(19) United States
(12) Patent Application Publication
(10) Pub. No.: US 2003/0136371 A1
(43) Pub. Date: Jul. 24, 2003

(54) Energy efficient fluid pump system

(76) Inventors: David Killion, Clarkston, MI (US); Brian Dunn, Mount Clemens, MI (US); David Neil Hutton, Halifax (GB); David Liddy, Plymouth, MI (US)

Correspondence Address: JOHN S. ARTZ, ARTZ & ARTZ, P.C., SUITE 250, 28333 TELEGRAPH ROAD, SOUTHFIELD, MI, 48034, US

(21) Appl. No.: 10/215,886

(22) Filed: Aug. 9, 2002

Related U.S. Application Data
(60) Provisional application No. 60/311,221, filed on Aug. 9, 2001.
(60) Provisional application No. 60/329,399, filed on Oct. 15, 2001.
(60) Provisional application No. 60/338,121, filed on Nov. 13, 2001.
(60) Provisional application No. 60/333,984, filed on Nov. 20, 2001.

(51) Int. Cl. F02B 77/00

(52) U.S. Cl. 123/198 C

(57) ABSTRACT

A fluid pumping system for an engine or other system which reduces the high speed driving power consumption by hydraulic unloading of the mechanically-driven pump element through the use of recirculation through a jet pump when a system fluid pressure target value is achieved. A pressure-activated flow control valve is utilized to efficiently recycle excessive flow volume from the pump through the jet pump and back to the pump's intake with minimized pressure loss, thereby hydraulically unloading the pump in comparison with conventional systems. Energy conservation by the jet pump and recirculation conduit acts to also prevent cavitation of the hydraulically unloaded pump element at high speeds. The fluid system is useful in conjunction with an engine balance shaft system to control gear rattle at low speeds without adding undue gear loads at high speeds.

### CROSS-REFERENCE TO RELATED APPLICATIONS

The present application claims priority from U.S. Provisional Application Serial No. 60/311,221, entitled “Energy Efficient Fluid Pump,” and filed Aug. 9, 2001; U.S. Provisional Application Serial No. 60/329,399, entitled “Energy Efficient Fluid Pump System,” and filed Oct. 15, 2001; U.S. Provisional Application Serial No. 60/338,121, entitled “Energy Efficient Fluid Pump System With Modified Valve System,” and filed Nov. 13, 2001; and U.S. Provisional Application Serial No. 60/333,984, entitled “Energy Efficient Fluid Pump System,” filed Nov. 20, 2001.

### TECHNICAL FIELD

The present invention relates to a fluid pump system for an engine or other system. More specifically, the present invention relates to an energy efficient fluid pump which allows for the reduction of driving power consumption through the use of a jet pump to efficiently recycle unneeded flow volumes and to prevent pump cavitation at high speeds. Such reduction of driving power consumption is desirable, for example, when the engine is operating above a pre-determined fluid pressure.

### BACKGROUND OF THE INVENTION

Fluid pump systems, and specifically oil pump systems, are well known in the art. In a typical automotive oil pump system, the oil pump is driven by an engine's crankshaft and is either located on the front of the engine or in the oil pan. Because the oil pump is driven by the crankshaft, it runs at a fixed speed ratio to the crankshaft for mechanical simplicity, wherein pump size and drive ratio are determined by the flow volume required to maintain oil pressure at low speeds. This combination of pump size and drive ratio typically, however, produces excessive flow volume, which may result in significant energy loss, at higher engine speeds.

The use of dual engine balance shafts for certain engines is known in the art to aid in balancing engine vibration and in reducing engine noise. Examples of the use of dual engine balance shafts are disclosed in U.S. Pat. No. 1,163,832 (Lanchester), U.S. Pat. No. 3,995,610 (Nakamura), and U.S. Pat. No. 5,535,643 (Garza). In operation, the balance shafts are connected to the engine crankshaft in such a way as to rotate at twice the crankshaft speed. The two balance shafts also rotate in opposite directions to cancel each other's lateral unbalance, thereby resulting in vertical shaking forces whose magnitude varies with engine speed or RPM. The balance shafts counterbalance the vertical shaking forces caused by the accelerations of the engine's reciprocating piston assemblies, in conjunction with the tilting of the connecting rods as required by their connection with the crankshaft.

One problem with the use of balance shafts is that the engine's firing and compression strokes alternately accelerate and decelerate the crankshaft's rotation. These angular accelerations of the crankshaft occur at all engine speeds. However, the resulting “Rigid Body Motion” angular displacements are greatest at low speeds, where the capacity for kinetic energy storage (a function of the square of velocity) by the engine's rotating inertia is low, and the time duration of the acceleration phases are high.

This low speed Rigid Body Motion can create objectional noise emissions known as gear rattle in balance shaft gear drive mechanisms, by alternately speeding up and slowing down the input shaft of gear driven counter-rotating balance shafts. The meshing clearance or backlash between the teeth of meshing opens and then closes potentially noisily, as the balance shafts attempt to maintain constant rotational speed by virtue of their inertia.

In an effort to reduce these noise problems, coupling a single oil pump to an engine balance shaft is known to be beneficial, by means of reducing tooth separation magnitudes. However, these efforts have typically resulted in inefficient systems that utilize more engine power than is necessary at high speeds, both from the generation of excess pump flow volumes, and from the twice engine speed sliding velocities of the pumping element, thereby penalizing fuel efficiency. Moreover, because of the increased engine power usage, the engine can generate more noise and oil temperature than is desired as it drives the oil pump. These challenges become even greater as system flow requirements increase, because with larger pumps operating at high speeds, cavitation due to the inability to completely fill the pump under existing conditions of pressure, speed, and fluid properties becomes a significant limitation.

It is known from general pumping technology to interconnect two or more pumps by a fluid control valve, in order to hydraulically unload one pump when flow demands have been met. However, the cost-effective utilization of a single fixed-displacement pumping element in communication with a pair of balance shafts and used in conjunction with recirculation through a jet pump to conserve already-invested energy is not known. Examples of such general pumping technology are shown in U.S. Pat. Nos. 4,306,840, 4,245,964, and 4,832,579. These general pumping technologies also fail to achieve maximum energy efficiency because they discharge the output of the hydraulically switched pump past a one-way valve to a common inlet manifold, which is operating at below atmospheric pressure to lift oil from the oil pan or oil sump, thereby discarding the pressure energy invested by the pump while admittedly providing the benefit of reducing the velocity of pick-up flow from the sump, and thus the extent of “vacuum” or pressure loss, at the pump's intake.

U.S. Pat. No. 5,918,573, issued to Assignee, discloses a dual pumping system that is intended to overcome many of these deficiencies by providing maximum energy efficiency. The disclosed dual pumping system may include an engine having at least one engine balance shaft. The system also includes a primary positive displacement pump which supplies its full output flow to the engine whenever the engine is running. The system further includes a secondary positive displacement pump, which supplies its full output flow only at low speeds. The output of the secondary positive displacement pump is efficiently managed by a fluid control valve that operates to divert the fluid flow from the secondary positive displacement pump away from the system load or engine when the system pressure reaches a predetermined level. This begins to occur when the pressure of the fluid reaches a threshold level at which the fluid control valve is forced to move to a position where it initiates the opening of a recirculation passageway that includes a jet pump to conserve already invested pressure energy. When the pressure increases to a higher level, above that of the threshold level, the excess output from the secondary positive displacement pump is diverted from the system load or engine by the flow control valve and recirculated through the jet pump back to its own intake, with the jet pump-conserved pressure hydraulically unloading the secondary pump and effectively postponing cavitation to speeds above the operating range. Inherent low speed noise emissions, due to the “pressure ripple” that accompanies inherent output flow rate variation, tend to be reduced by the division of total output displacement between two phased, or else different order, pumping elements. High-speed noise emissions are minimized by cavitation avoidance, and are also potentially reduced by the supplemental pump's hydraulic unloading.

While this improved energy-efficient dual element system works well, it tends to require more packaging space and manufacturing cost than a single pump system because of its relatively greater complexity. It would thus be desirable to provide a pump system that provides at least some of the desired noise reduction, energy efficiency, and anti-cavitation benefits of the dual-element energy efficient fluid pump system at reduced cost and with reduced space requirements.

### SUMMARY OF THE INVENTION

It is an object of the present invention to provide a fluid pumping system that reduces “pressure ripple” noise and eliminates cavitation noise, while increasing the energy-efficiency of the pump system by reducing power consumption at high speeds, as compared to conventional art single pumping element systems.

It is another object of the present invention to provide a positive displacement pump system that is drivingly connected to an engine having gear driven balance shaft(s) to provide the engine with a cost-effective means of avoiding gear noise emissions.

It is still another object of the present invention to reduce packaging space requirements and manufacturing cost as compared to prior art energy-efficient systems with dual pumping elements.

It is a related object of the present invention to enable safe, quiet, and reliable operation at greater flow capacity and/or higher pump speeds than possible with cavitation-limited conventional art.

In accordance with the above and the other objects of the present invention, a fluid pumping system is provided. The fluid pumping system includes a positive displacement pump, drivingly connected to an engine or other motive source, which operates to supply fluid flow volume to pressurize an engine or other hydraulic load (hereafter called the engine). The system also includes a normally non-passing pressure control valve (hereinafter “control valve”) on the discharge side of the pump which opens, at a predetermined pressure, a conduit to the nozzle of a jet pump-like structure, whose throat and diffuser in turn feed the intake side of the positive displacement pump; and a fluid (hereafter called oil) supply (hereafter called the sump), which may include a conduit to the jet pump-like structure, or alternatively may itself simply submerge the jet pump-like structure, for the supply of oil to the jet pump-like structure throat to replace that delivered to the engine as well as oil that may have leaked from the pump or elsewhere in the system. The conduits from the valve to the jet pump-like structure, the nozzle, the throat and diffuser of the jet pump-like structure, and the conduit from the jet pump-like's diffuser to the pump's inlet port, collectively comprise the so-called recirculation passageway. The conduit from the pump outlet opening to the engine can be located either between the pump and the valve, or else incorporated into the valve itself, such that the valve and the recirculation passageway represent an escape route for fluid in excess of that needed to maintain target system pressure, or so-called “pilot pressure”.

Alternative embodiments of this simplest “essence” of the energy efficient fluid pump system, include a valved discharge to the engine, which can serve to increase nozzle pressure for increased cavitation resistance; and/or the inclusion of another pumping element, whose contribution to total flow requirements also acts to improve jet pump efficiency by increasing excess flow, and thereby increasing the nozzle pressure and the flow rates at high speed.

These and other features and advantages of the present invention will become apparent from the following description of the invention, when viewed in accordance with the accompanying drawings and appended claims.

### BRIEF DESCRIPTION OF THE DRAWINGS

FIG. 1 is a schematic illustration of a normally non-passing pressure control valve (“control valve”) in a closed position and a flow circuit in accordance with one preferred embodiment of the present system when the pump is in full communication with the engine;

FIG. 2 is schematic illustration of a flow circuit for the embodiment of the control valve of FIG. 1 in a second position, corresponding to a predetermined system pressure, where the engine is operating at high idle, and where the recirculation passageway is about to open;

FIG. 3 is a schematic illustration of a flow circuit for the embodiment of the control valve of FIG. 1 in a transitional position where the control valve is partially opening the recirculation passageway;

FIG. 4 is a schematic illustration of a flow circuit for the embodiment of the control valve of FIG. 1 in an open position with the recirculation passageway in a completely open position;

FIG. 5 is a schematic illustration of a control valve in a closed position and a flow circuit in accordance with another preferred embodiment of the system when the pump is in full communication with the engine;

FIG. 6 is schematic illustration of a flow circuit for the embodiment of the control valve of FIG. 5 in a second position, corresponding to a predetermined system pressure, where the engine is operating at high idle and the recirculation passageway is about to open;

FIG. 7 is a schematic illustration of a flow circuit for the embodiment of the control valve of FIG. 5 in a transitional position where the control valve is partially opening the recirculation passageway and partially restricting the discharge through the pump outlet passageway to the engine;

FIG. 8 is a schematic illustration of a flow circuit for the embodiment of the control valve of FIG. 5 in an open position with the recirculation passageway in a completely open position and the discharge to the engine through the pump outlet passageway is substantially, but not completely closed;

FIG. 9 is a schematic illustration of a flow circuit with a control valve in a closed position in accordance with still another preferred embodiment of the system where both pump elements are in full communication with the engine;

FIG. 10 is a schematic illustration of a flow circuit for the embodiment of FIG. 9 with the control valve in a second position corresponding to a predetermined system pressure, where the engine is operating at high idle and the recirculation passageway is about to open;

FIG. 11 is a schematic illustration of a flow circuit for the embodiment of FIG. 9 with the control valve in a transitional position where the recirculation passageway is partially open and only the first pump is fully providing fluid to the engine;

FIG. 12 is a schematic illustration of a flow circuit for the embodiment of FIG. 9 with the control valve in a bypass threshold position where the recirculation passageway is completely open and the second pump is in a full recirculation mode;

FIG. 13 is a schematic illustration of a flow circuit for the embodiment of FIG. 9 with the control valve in a fully open position with the recirculation passageway being completely open and the bypass outlet exposed; and

FIG. 14 is a perspective view of a pair of balance shafts having an oil pump disposed thereon in accordance with a preferred embodiment of the present invention.

### BEST MODE(s) FOR CARRYING OUT THE INVENTION

Preferred embodiments of the present invention are shown in the drawings and are described in more detail below. In short, the Applicants have discovered that the barest “essence” of U.S. Pat. No. 5,918,573, namely the supplemental pump with its jet pump assisted recirculation of excess flow volume as regulated by a normally non-passing pressure control valve, can act viably as a stand alone energy-efficient pump system, i.e., without the need for the primary pump in parallel, without the valved intake passageway, and without the valved discharge to the load passageway, so long as design parameters to assure appropriate so-called “capacity ratio” and nozzle/throat area ratio are chosen.

In the case of such a stand alone energy-efficient pump, as disclosed herein, the capacity ratio of a conventional jet pump system is approximated in the positive displacement pump application, by flow volume delivered to load divided by excess flow volume diverted through the jet pump nozzle. The choice of nozzle/throat area ratio influences the maximum useful capacity ratio, but in any case the preferred maximum useful capacity ratio for a fixed nozzle/throat area ratio system is around 2.4, so system parameter choices must be made to assure sufficient excess flow volume and in order to gain tangible jet pump benefits. It will be understood that a variety of ratios may be utilized and still achieve the objects of the present invention. These parameter choices include pump size and drive ratio such that the maximum speed discharge from the pump is sufficiently greater than the delivered-to-load flow volume, a choice which tends to increase the low speed rate of the system pressure rise vs. RPM, which in turn serves to benefit engine devices which rely on hydraulic pressure for their functionality.

In particular, a recent trend toward the use of hydraulically actuated variable camshaft timing (VCT) for improved economy, torque, and emissions control will also benefit by the ability of engine VCT phasers to gain low speed responsiveness by the more rapid pressure rise afforded by a properly designed jet pump-assisted energy-efficient fluid pump system, as disclosed herein. Additionally, the cavitation avoidance benefit of the disclosed system enables such high displacement design choices to be made safely, a substantial advantage over conventional single pump systems especially when a twice engine speed pump architecture is chosen for gear rattle control, see e.g. Garza.

Referring now to the Figures, a preferred embodiment of an oil pump system 10, in accordance with the present invention, is disclosed. The present invention is not intended to be limited to an oil pump system and may be utilized in any fluid pumping system any may be utilized with a variety of other fluids. The following description of an oil pump system is merely illustrative and will be understood as such by one of skill in the art.

The type of oil pump used with the present invention is preferably a positive displacement pump. Pumps of this type include internal tip-sealing rotors, hereafter referred to as “Gerotor” pumps, vane pumps, gear pumps, and piston pumps. For purposes of illustrating the present application, a Gerotor-type pump is utilized which also constitutes the preferred form of the invention. However, it is to be understood that any other pump can be utilized and that the depiction of a Gerotor pump is simply illustrative. Hereinafter, this element will be referred to simply by the term “pump”.

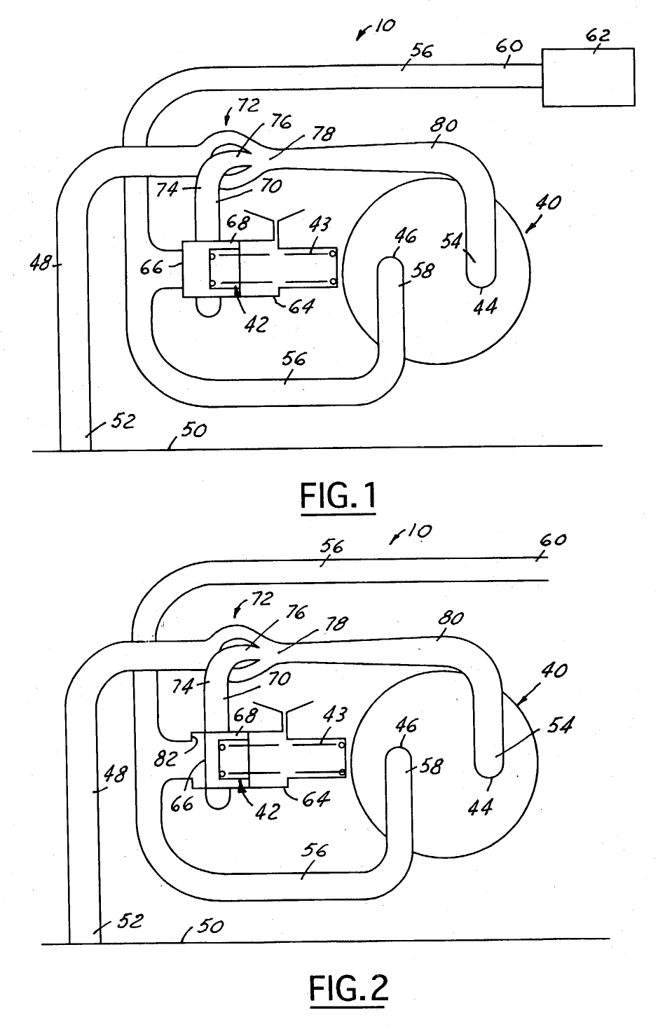

As shown schematically in the embodiment illustrated in FIGS. 1 through 4, the oil pump system 10 includes a pump 40 that is in communication with a normally non-passing pressure control valve 42 (hereinafter referred to as “control valve”) to divert excess flow to the jet pump-like nozzle when the pressure in the system 10 reaches a predetermined threshold. The pump 40 has in inlet opening 42 and an outlet opening 44. The pump 40 is preferably a positive displacement pump and more preferably is a Gerotor oil pump, which is well known in the art and its configuration will not be discussed in detail. It will be understood that a variety of other pumps, may also be utilized.

The system 10 also includes an inlet fluid passageway 48 that is in communication with an oil sump 50 at a first end 52 and in communication with the inlet opening 42 at a second end 54. A jet pump-like structure 72, as described in more detail below, is disposed in the fluid passageway 48 between the first end 52 and the second end 54. The system 10 also includes an outlet fluid passageway 56. The outlet fluid passageway 56 has a first end 58 that is in communication with the pump outlet opening 44 and a second end 60 that is in communication with the system load or engine 62.

The control valve 42 is preferably disposed and reciprocal within a valve housing 64. In accordance with the present invention, the normally non-passing pressure control valve 42 is configured to be very pressure sensitive, in terms of its area opening rate, which is important to achieving both cavitation resistance and energy efficiency gains of hydraulic unloading. This pressure sensitivity of the control valve 42 allows it to move and thereby allow recirculation flow once the threshold pressure is reached, in order for the jet pump nozzle to represent the principal flow restriction. To the extent that the control valve 42 creates a pressure drop due to its own restriction, already invested pressure energy is lost to heat instead of contributing to the pump inlet pressure boost from which cavitation resistance and hydraulic unloading derive. This pressure sensitivity may be accomplished by the combination of soft spring rate and significant preload compression on a biasing spring, and preferably a full-circumferential opening area to feed the recirculation passageway 70 to the jet pump-like nozzle 76.

Also, the velocity pressure of axial intake flow impinging on the active face of the control valve 42 may preferably be employed to offset the increased force of the biasing spring due to increased valve displacement. It will be understood, however, that this compensation should not be overdone to the point of instability. A valve motion dampening orifice in communication with an “always-filled” fluid reservoir is also preferably used to “vent” the otherwise sealed spring pocket to provide shock absorber action to counteract valve resonance.

FIGS. 1 through 4 illustrate a preferred embodiment of the oil pump system 10 and the normally non-passing pressure control valve 42 in accordance with the present invention. As shown, FIG. 1 illustrates the system 10 when the control valve 42 is in a normally closed position. The control valve 42 is preferably biased to the closed position by a spring 43 or other biasing mechanism. The biasing spring 43 is preferably selected based on the factors discussed above, in order to achieve the objects of the present invention. In the exemplary embodiment shown in FIG. 1, the closed configuration of the control valve 42 corresponds to conditions when the system 10 is operating at low pressures. In the normally closed position, the control valve 42 forces the pump 40 to convey fluid (oil) from the oil sump 50 to the engine 62 through the inlet fluid passageway 48 and the outlet fluid passageway 56. The control valve 42 has a face portion 66 that is exposed to the outlet fluid passageway 56 and rests on a shoulder portion 82 formed in the valve housing 64. The control valve 42 also has a valve body 68 located within the valve housing 64. It will be understood that the configuration of the control valve 42 and associated passageways is shown for purposes of illustration only and is not intended to be limiting.

As shown in FIG. 2, when the pressure in the system 10 begins to increase, the pressure in the outlet fluid passageway 56 acts on the face portion 66 of the control valve 42 and moves it against the force of the biasing spring 43, such that the face portion 66 is not resting on the shoulder portion 82. This position of the control valve 42 is generally referred to as the beginning transition position, which is characterized by an increase in system pressure that does not exceed the threshold pressure. In this configuration, the pressure acting on the valve body 68 has moved it slightly away from the shoulder portion 82. However, in this position, the valve body 68 is still completely blocking off the recirculation passageway 70, which is a fluid opening formed in the valve housing 64. Thus, all the fluid pulled by the pump 40 from the oil sump 50 is being transferred to the engine 62 in this condition.

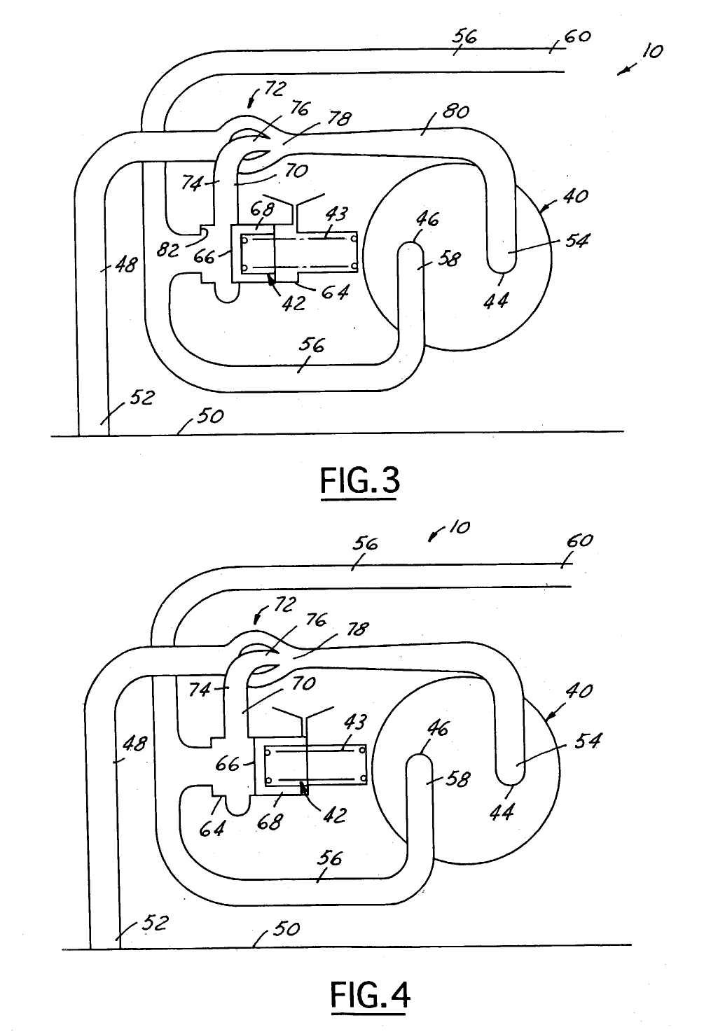

FIG. 3 illustrates a preferred embodiment of the oil pump system 10 where the control valve 42 is in a transition position. In the transition position, the pressure in the outlet fluid passageway 56 has increased to a level such that enough pressure has been exerted on the face portion 66 to move the valve body 68 within the valve housing 64 enough to partially open the recirculation passageway 70. As is well known, when the pressure in the system 10 exceeds the predetermined threshold level the same amount of oil is not needed by the engine. Thus, the recirculation passageway 70 allows excess flow volume (that which is not needed by the load device or engine) to bypass the engine 62 and be diverted back to the inlet opening 44 of the pump 40. Thus, in the transition position, shown in FIG. 3, the recirculation passageway 70 is slightly open such that any necessary fluid can flow to the engine 60 and any excess fluid can flow through the recirculation passageway 70 back to the inlet opening 44.

FIG. 4 illustrates the oil pump system 10 when the pressure is high, such as when the engine is operating at high speeds. When the pressure in the oil pump system 10 is high, the control valve 42 is in a fully open position. In the open position, the pressure in the outlet fluid passageway 56 has increased to a level such that the force acting on the face portion 66 is sufficient to move the valve body 68 to a position such that the recirculation passageway 70 is fully exposed. Again, in this position, the recirculation passageway 70 allows excess flow volume (that which is not needed by the load device or engine) to bypass the load and be diverted back to the inlet opening 44 of the pump 40. When the control valve 42 is in the open position, the recirculation passageway 70 is fully open such that fluid can flow to the engine 62 with any excess fluid flowing through the recirculation passageway 70 to the inlet opening 44.

The recirculation passageway 70 includes a jet pump-like structure 72 disposed therein. The jet pump-like structure 72 is located where the recirculation passageway 70 and the inlet fluid passageway 48 meet. The jet pump-like structure 72 is oriented so as to discharge its flow in a substantially downstream, or toward the inlet opening 44 of the pump 40, direction and thus assists in downstream preservation of the discharge or pilot fluid pressure and delivers it along with any make-up fluid thereby drawn from the oil sump 50 to the inlet opening 44 of the pump 40 for cavitation resistance and hydraulic unloading benefits. The jet pump-like structure 72 is preferably configured to maximize pressure in the downstream passage 80 to the inlet opening 44 of the pump 40. When the system 10 is operating under conditions wherein this pressure is needed, then for at least some applications, the valving of the sump-to-jet pump intake passage (inlet fluid passageway 48) is unnecessary. The elimination of this required functionality from the control valve 42 represents opportunity for cost savings, space efficiency improvement, and performance increase. The performance is increased because reduced restriction in the sump-to-jet pump passage 48 translates to increased (ant-i-cavitation) pressure in the jet pump-to-pump inlet passageway 80. An alternative advantage of this reduced restriction is the ability to sustain increased velocities in the jet pump-to-pump inlet passageway 80, which is another packaging space benefit.

In the preferred embodiment, the jet pump-like structure 72 includes the portion 74 of the recirculation passageway 70 between the valve housing 64 and the jet pump-like structure 72, a nozzle portion 76, a throat portion 78, and the portion 80 of the recirculation passageway 70 between the jet pump-like structure 72 and the inlet opening 44. The jet pump-like structure 72 is preferably configured such that the main fluid flow velocity is used to create a drop in pressure therearound and thus pull fluid from the surrounding areas. In the preferred configuration, the center stream from the recirculation passageway 70 is configured to pull oil from the oil sump 50 through the inlet fluid passageway 48 into its flow from the sides to keep the intake flow to the pump 40 fully supplied.

In the preferred embodiment, the jet pump-like structure 72 is a jet pump with the inlet fluid passageway 48 being arrayed circumferentially around the nozzle portion 76 or center stream provided by the recirculation passageway 70. However, it will be understood that the jet pump-like orifice 72 should be construed to encompass a variety of other known configurations, including an inverted or inside out arrangement where the nozzle flow is supplied from the periphery of the throat, so as to help pull fluid through a center stream drawn from the oil sump 50 or other fluid source.

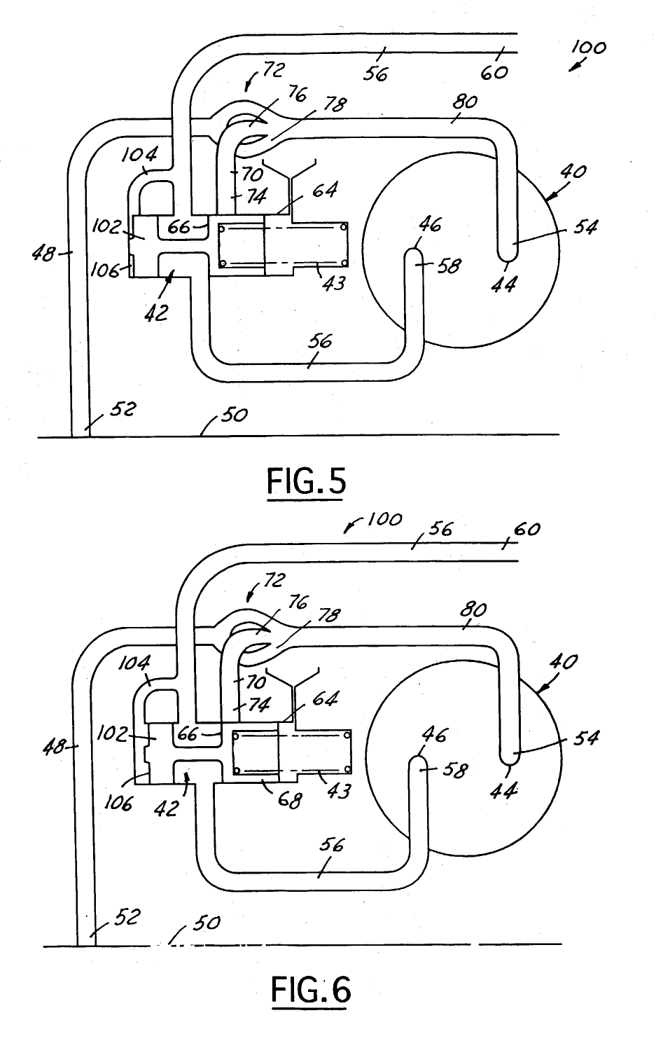

FIGS. 5 through 8 illustrate another exemplary embodiment of an oil pump system 100 in accordance with the present invention. In these Figures, like components are given like reference numbers. The principal difference between this embodiment shown in FIGS. 5 through 8 and the previous embodiment of FIGS. 1 through 4 is the configuration of the control valve 42. In this embodiment, the control valve 42 is of a “dumbbell style” with a plunger portion 102 and a spool portion 104 that extends between the face portion 66 and the plunger portion 102. Further, as discussed in more detail below, this embodiment discloses a valved discharge. In this embodiment, the discharge passageway to the engine is branched from the recirculation passageway within the valve itself, an improvement over the U.S. Pat. No. 5,918,573 disclosure of the discharge and the recirculation passage being branched upstream of a more complex valve having separate chambers for each passage divided by a valve member sealing partition. The single inlet to dual outlet valve configuration is common usage art having potentially greater flow resistance due to the abruptness of its within-the-valve branching than the U.S. Pat. No. 5,918,573 style valve, but enabling the beneficial freedom from oil flow impingement on exposed areas of the valve member with attendant risk of side loading at high flow velocities of the U.S. Pat. No. 5,918,573's partitioned valve.

FIG. 5 illustrates the control valve 42 in a closed position as biased by the spring 43. In the exemplary embodiment shown in FIG. 5, the closed configuration of the control valve 42 corresponds to conditions when the system 100 is operating at low pressures. In this position, the control valve 42 forces the pump 40 to convey fluid (oil) from the oil sump 50 to the engine 62 through the inlet fluid passageway 48 and the outlet fluid passageway 56.

When the pressure in the system begins to increase, the control valve 42 is moved to a start transition position, such as is shown in FIG. 6. In this position, the pressure in the outlet fluid passageway 56 acts on the face portion 66 as well as on the face portion 106 of the plunger portion 102 through the conduit 104 to move the control valve 42 against the force of the spring 43.

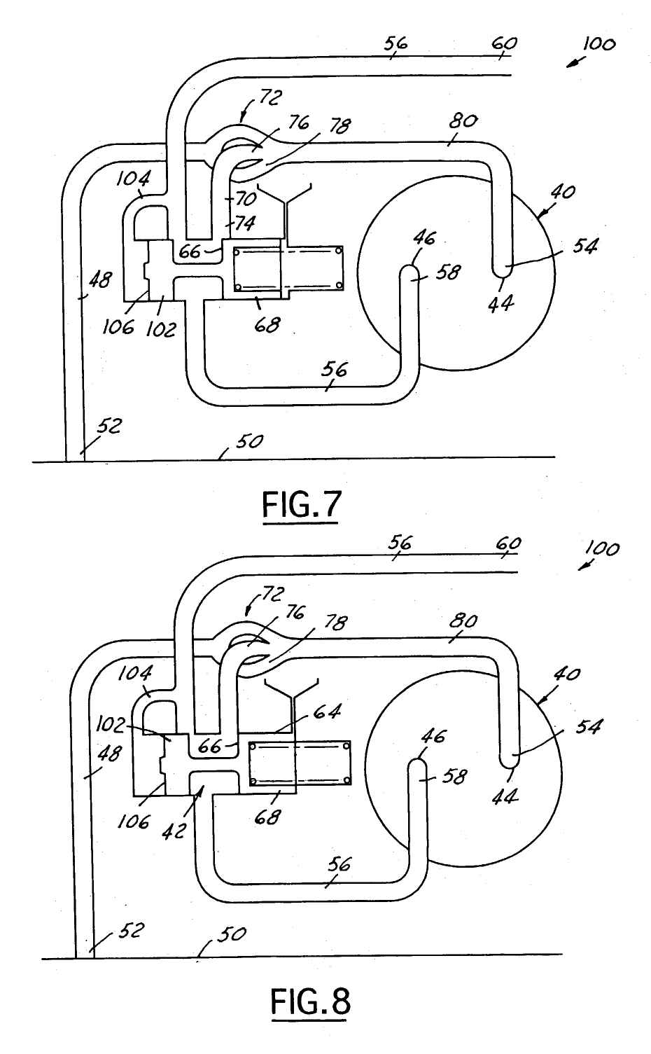

When the pressure in the system reaches or begins to exceed the threshold pressure, the control valve 42 moves to the transitional position, shown in FIG. 7. In this position, the pressure acting on the face portions 66 and 106 causes the control valve 42 to move such that the plunger portion 102 begins to block off the flow of fluid in the outlet fluid passageway 56 from the outlet opening 46 to the engine 62. At the same time, the valve body 68 begins to open the recirculation passageway 70.

FIG. 8 illustrates the system in a full bypass position. In this position, the threshold pressure has been exceeded and the control valve 42 is moved such that the recirculation passageway 70 is fully open and the plunger portion 102 is substantially blocking the flow of fluid from the pump outlet opening 46 to the engine 62. It will be understood that the system 100 can take on a variety of other configurations, for example, the valve 42 can be configured to also limit the flow fluid through the inlet fluid passageway 48. Thus, substantially all of the fluid expelled from the pump outlet opening 46 travels through the recirculation passageway 70 to the pump inlet opening 44. It will be understood that with this configuration, the pressure at the nozzle 76 of the jet pump 72 is increased, due to the partial blockage of the outlet fluid passageway 56.

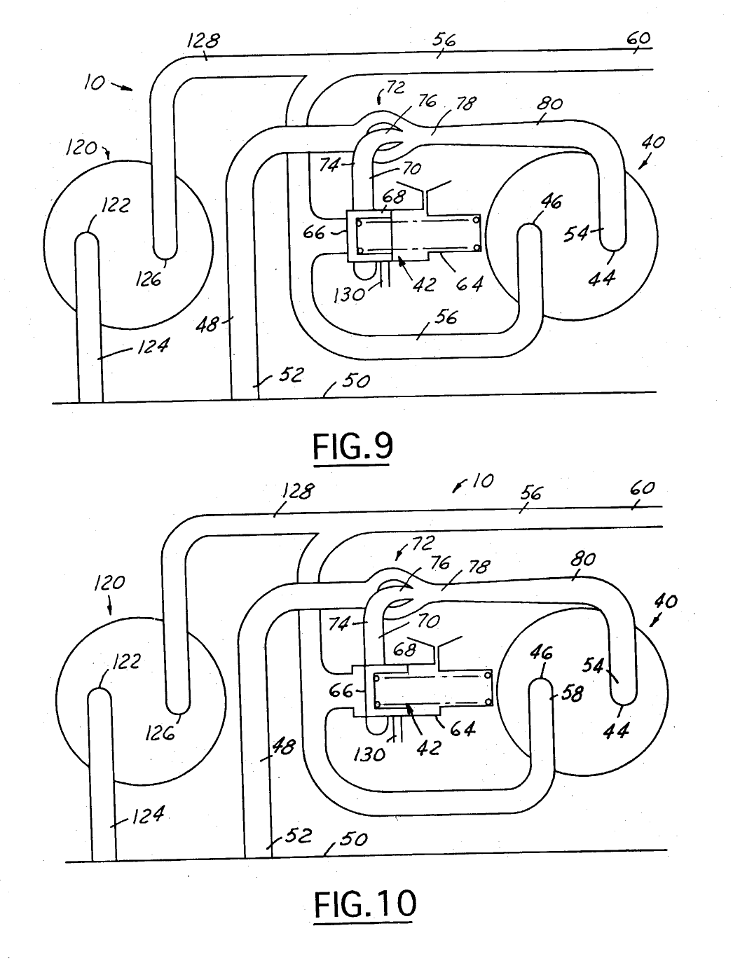

FIGS. 9 through 13 illustrate another embodiment in accordance with the present invention. In the Figures, like components are given like reference numbers. In this embodiment, the system 10 includes another pump element 120. The other pump element 120 is intended to operate such that it conveys oil to the engine 62 at all speeds and pressures. Thus, when the system 10 is operating at low speeds, the pump 120 and the pump 40 are both conveying fluid to the engine. This configuration is shown best in FIG. 9.

Referring now to the exemplary embodiment shown in FIG. 9, which illustrates a system 10 with the valve in the closed position as biased by a spring. The closed position corresponds to low system speed and pressure. In this exemplary embodiment, the system 10 includes two pumps, namely, the pump 40 and a pump 120. The pump 120 has an inlet opening 122 that is in communication with the oil sump 50 by an inlet passageway 124. The pump 120 also has an outlet opening 126. The pump 120 conveys fluid from the outlet opening 126 through a discharge passageway 128 to the engine. The discharge passageway 128 and the outlet fluid passageway 56 preferably intersect at a point upstream of the engine 62.

When the pressure in the system 10 reaches a predetermined value, the control valve 42 is moved to a start transition or second position, such as is shown in FIG. 10. In this position, the pressure in the outlet fluid passageway 56 acts on the face portion 66 of the control valve and moves it against the force of the spring 43 away from the shoulder portion 82 of the valve housing 64. In the start transition position, both pumps 40 and 120 are conveying oil to the engine 62.

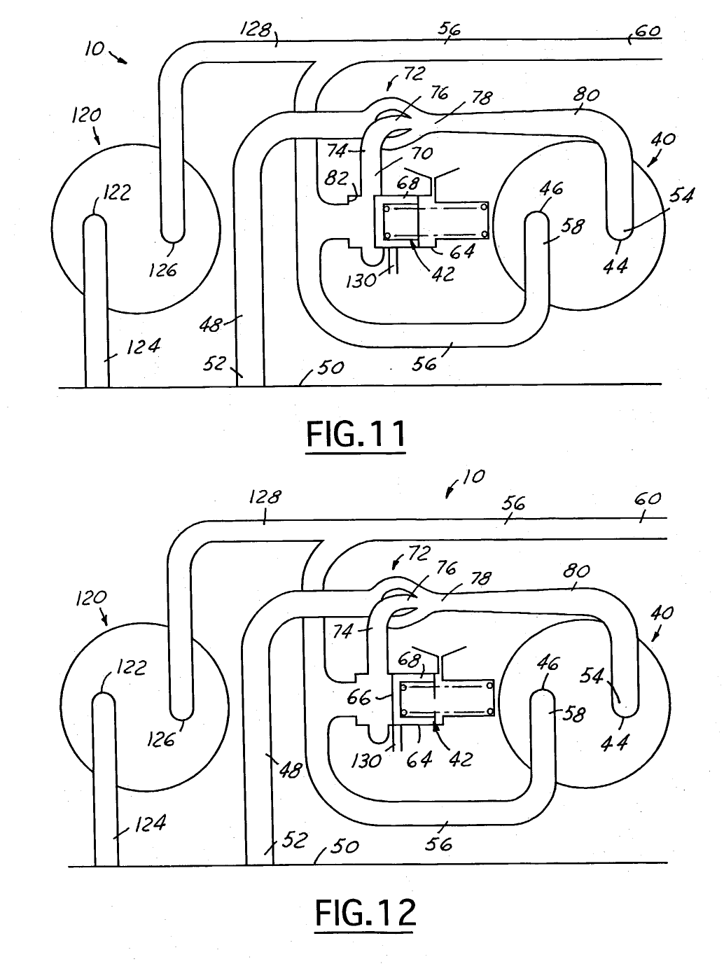

When the pressure in the system exceeds the target pressure, the control valve 42 moves to the transitional position, which is shown in FIG. 11. In this position, the pressure acting on the face portion 66 causes the control valve 42 to move such that the valve body 68 begins to open the recirculation passageway 70. In the transitional position, the pump 120 is fully conveying oil to the engine 62 and the pump 40 is only conveying oil to the engine 62 as is necessary, while the unneeded or excess oil is passed through the recirculation passageway 70 back to the pump 40.

FIG. 12 illustrates the system in a bypass threshold position. In this position, the target pressure has been exceeded and the control valve 42 is moved such that the recirculation passageway 70 is fully open. In the bypass threshold position, the pump 120 is fully conveying oil to the engine 62 and the pump 40 is only conveying oil to the engine 62 as is necessary, while the unneeded or excess oil is passed through the recirculation passageway 70 back to the pump 40. Thus, under many conditions only the pump 120 will be providing oil through the outlet fluid passageway 56 to the engine 62, while the output of the pump 40 is fully recirculated to its own inlet.

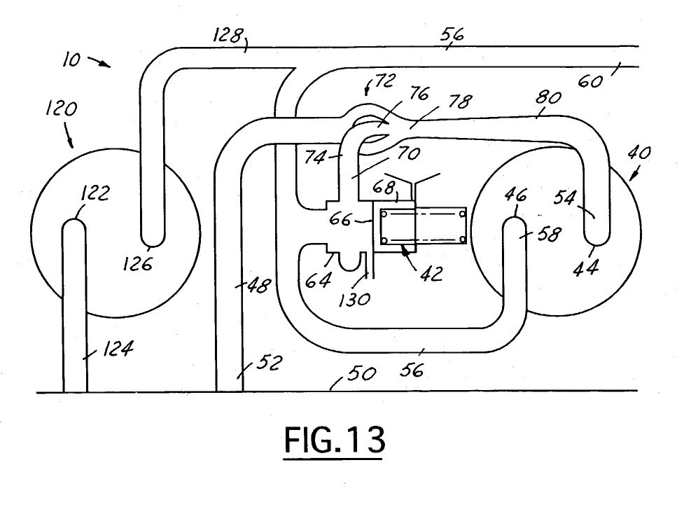

FIG. 13 illustrates the system in a full bypass position. In this position, the bypass pressure has been exceeded and the control valve 42 is moved such that the recirculation passageway 70 is fully open. Further, the control valve 42 has been moved to a fully open position such that a bypass port 130 has been opened. In the bypass position, the output flow of the pump 40 is fully recirculated and the output of the pump 120 exceeds the demands of the engine, so that the bypass port allows its excess fluid to be expelled to the oil sump 50.

It will be understood that the system 100 can take on a variety of other configurations, for example, the valve 42 can be configured as shown in FIGS. 5 through 8. It will be understood that with this configuration, the pressure at the nozzle 76 of the jet pump 72 is increased, due to the partial blockage of the outlet fluid passageway 56.

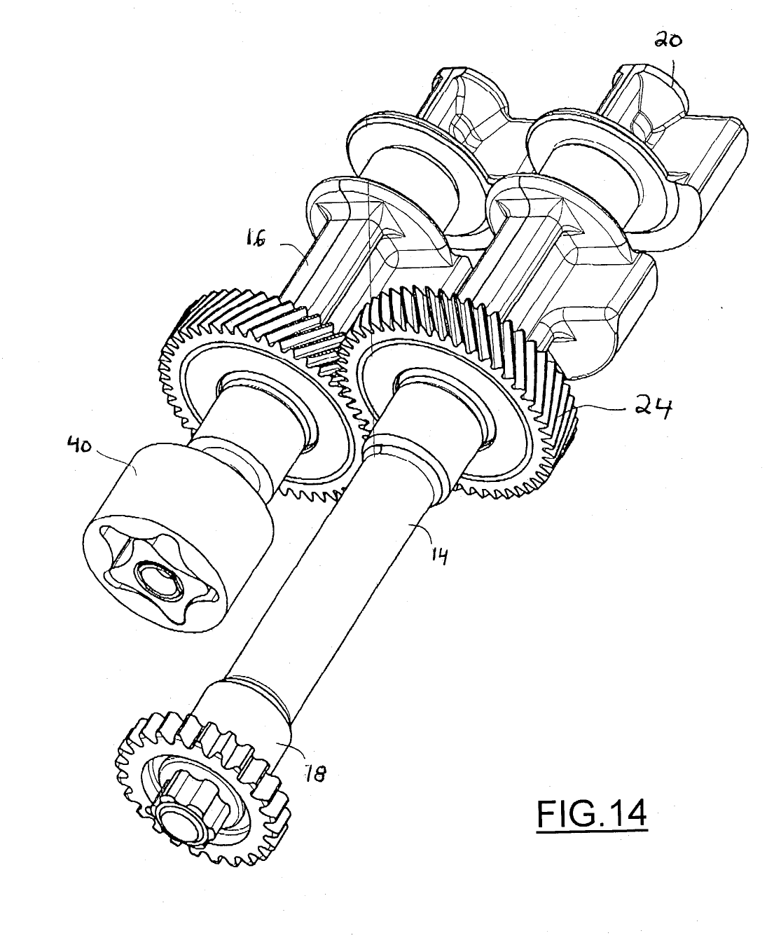

Referring now to FIG. 14, which illustrates a preferred application of the oil pump system 10 of the present invention. In accordance with the present invention, the oil pump system 10 is preferably part of a vehicle engine (not shown). The oil pump system 10 is preferably in communication with a pair of twin counter-rotating balance shafts 14, 16 which help counteract the secondary shaking forces of an inline four cylinder internal combustion piston engine. The pair of twin counter-rotating balance shafts comprises a primary balance shaft 14 and a secondary balance shaft 16. The primary balance shaft 14 is the driving shaft, while the secondary balance shaft 16 is the slave or driven balance shaft. The primary balance shaft 14 has an input end 18 and an output end 20. It will be understood that the orientation of the ends 18, 20 in the figures is merely for purposes of illustration. The ends 18, 20 can be reversed or differently configured in accordance with the present invention. The input end 18 of the primary balance shaft 14 is preferably in communication with an engine crankshaft (not shown).

The input end is preferably in direct communication with the engine crankshaft through a sprocket or gear 22 that allows the primary balance shaft 14 to be driven at a certain ratio, which preferably is a 2:1 ratio. Alternatively, the crankshaft can be in communication with the primary balance shaft 14 through an intermediate shaft or other commercially known method. As is well known, the primary balance shaft 14 is in communication with a gear 24. In the illustrated embodiment, the gear 24 is illustrated as located at the output end 20 of the primary balance shaft 14 however; the location of the gear 24 is a matter of design choice. It will be understood that the gear 24 is in meshing relationship with a corresponding gear on the secondary balance shaft 16 to effectuate counter rotation as well as timing of the shafts.

Having now fully described the invention, it will be apparent to one of ordinary skill in the art that many changes and modifications can be made thereto without departing from the spirit or scope of the invention as set forth herein.

What is claimed is:

1. A fluid pump system comprising:
a jet pump like configuration in communication with a fluid supply;
a positive displacement pump having an intake port that receives fluid from said jet pump, and a discharge port;
a normally non-passing pressure control valve that is in fluid communication with said pump's discharge port, said pressure control valve being movable between a normally closed position and an open position;
a recirculation conduit that connects said pressure control valve with a nozzle of said jet pump;
wherein when the system is operating at low pressures, said pressure control valve is in said normally closed position and said system is provided with fluid from said pump discharge port; and
wherein when the system is operating at high pressures said pressure control valve is moved toward said open position enabling excess volumes of said fluid from said pump discharge port to escape through said recirculation conduit and jet pump nozzle to said pump intake port such that potential and kinetic energy of the excess fluid flow volumes are partially recaptured, and the absolute pressure of fluid flow to said intake port is thus increased.

2. The system of claim 1, wherein said pump is drivingly connected to a driven gear such that it's driving torque serves to decelerate said gear wherever possible.

3. The system of claim 2, wherein said driven gear is drivingly connected to a balance shaft of an internal combustion piston engine.

4. The system of claim 1, wherein said jet pump is of inside-out nozzle-throat architecture having nozzle function relocated to boundary layer area annular gap circumscribing the throat area.

5. The system of claim 1, wherein said jet pump is of adjustable nozzle configuration.

6. The system of claim 5, wherein adjustment of said adjustable nozzle is actuated by, and thereby responsive to, hydraulic pressure.

7. The system of claim 4, wherein said pump is drivingly connected to a driven gear such that it's driving torque serves to decelerate said gear wherever possible.

8. The system of claim 5, wherein said pump is drivingly connected to a driven gear such that it's driving torque serves to decelerate said gear wherever possible.

9. The system of claim 6, wherein said pump is drivingly connected to a driven gear such that it's driving torque serves to decelerate said gear wherever possible.

10. The system of claim 7, wherein said driven gear is drivingly connected to a balance shaft of an internal combustion engine.

11. The system of claim 8, wherein said driven gear is drivingly connected to a balance shaft of an internal combustion engine.

12. The system of claim 9, wherein said driven gear is drivingly connected to a balance shaft of an internal combustion engine.

13. The system of claim 1, wherein said pump is drivingly connected to a balance shaft of an internal combustion engine.

14. The system of claim 4, wherein said pump is drivingly connected to a balance shaft of an internal combustion engine.

15. The system of claim 5, wherein said pump is drivingly connected to a balance shaft of an internal combustion engine.

16. The system of claim 6, wherein said pump is drivingly connected to a balance shaft of an internal combustion engine.

17. The system of claim 1, further comprising:
a fluid outlet passageway in communication with said pump discharge port at one end and a system load at another end; and
wherein said pressure control valve substantially closes off said fluid outlet passageway when said pressure control valve completely opens said recirculation passageway, without fully closing off said fluid outlet passageway.

18. The system of claim of claim 1, further comprising:
a second positive displacement pump in parallel with said pump element.

19. The system of claim 18, further comprising:
a fluid outlet passageway in communication with said pump discharge port at one end and a system load and another end; and
wherein said pressure control valve substantially closes off said fluid outlet passageway when said pressure control valve completely opens said recirculation passageway, without fully closing off said fluid outlet passageway.

20. A fluid pump system comprising:
a jet pump like configuration in communication with a fluid supply;
a first positive displacement pump having an intake port that receives fluid from said jet pump, and a discharge port;
a second positive displacement pump in parallel with said first positive displacement pump;
a normally non-passing pressure control valve that is in fluid communication with said discharge port of said first pump, said pressure control valve being movable between a normally closed position and an open position;
a recirculation conduit that connects said pressure control valve with a nozzle of said jet pump;
wherein when the system is operating at low pressures, said pressure control valve is in said normally closed position and said system is provided with fluid from said discharge port of said first pump;
wherein when the system is operating at high pressures said pressure control valve is moved toward said open position enabling excess volumes of said fluid from said first pump discharge port to escape through said recirculation conduit and jet pump nozzle to said first pump intake port such that potential and kinetic energy of the excess fluid flow volumes are partially recaptured, and the absolute pressure of fluid flow to said intake port is thus increased; and
wherein said second pump provides fluid to a load at during all conditions of operation.

21. The system of claim 20, wherein said first pump is drivingly connected to a driven gear such that it's driving torque serves to decelerate said gear wherever possible.

22. The system of claim 21, wherein said driven gear is drivingly connected to a balance shaft of an internal combustion piston engine.

23. The system of claim 20, wherein said jet pump is of inside-out nozzle-throat architecture having nozzle function relocated to boundary layer area annular gap circumscribing the throat area.

24. The system of claim 20, wherein said jet pump is of adjustable nozzle configuration.

25. The system of claim 24, wherein adjustment of said adjustable nozzle is actuated by, and thereby responsive to, hydraulic pressure.

26. The system of claim 23, wherein said first pump is drivingly connected to a driven gear such that it's driving torque serves to decelerate said gear wherever possible.

27. The system of claim 24, wherein said first pump is drivingly connected to a driven gear such that it's driving torque serves to decelerate said gear wherever possible.

28. The system of claim 25, wherein said first pump is drivingly connected to a driven gear such that it's driving torque serves to decelerate said gear wherever possible.

29. The system of claim 26, wherein said driven gear is drivingly connected to a balance shaft of an internal combustion engine.

30. The system of claim 27, wherein said driven gear is drivingly connected to a balance shaft of an internal combustion engine.

31. The system of claim 28, wherein said driven gear is drivingly connected to a balance shaft of an internal combustion engine.

32. The system of claim 20, wherein said first pump is drivingly connected to a balance shaft of an internal combustion engine.

33. The system of claim 23, wherein said first pump is drivingly connected to a balance shaft of an internal combustion engine.

34. The system of claim 24, wherein said first pump is drivingly connected to a balance shaft of an internal combustion engine.

35. The system of claim 25, wherein said first pump is drivingly connected to a balance shaft of an internal combustion engine.

36. The system of claim 20, further comprising:
a fluid outlet passageway in communication with said first pump discharge port at one end and a system load at another end; and
wherein said pressure control valve substantially closes off said fluid outlet passageway when said pressure control valve completely opens said recirculation passageway, without fully closing off said fluid outlet passageway.
